(19) United States
(12) Patent Application Publication
(10) Pub. No.: US 2003/0021577 A1
(43) Pub. Date: Jan. 30, 2003

(54) Plastic optical fiber and process for its production

(75) Inventors: Norihide Sugiyama, Kanagawa (JP); Masaki Naritomi, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: ASAHI GLASS COMPANY LIMITED, Tokyo (JP)

(21) Appl. No.: 10/197,351

(22) Filed: Jul. 18, 2002

(30) Foreign Application Priority Data
Jul. 18, 2001 (JP) 2001-218380

(51) Int. Cl. G02B 6/16

(52) U.S. Cl. 385/143; 385/145; 385/123

(57) ABSTRACT

A plastic optical fiber which comprises a core made of a non-crystalline fluoropolymer (a) having substantially no C—H bond, and a clad made of a fluoropolymer (b) having a refractive index lower by at least 0.001 than the fluoropolymer (a), and of which the propagation mode is a single mode.

The present invention relates to a plastic optical fiber for communications with a high bandwidth, of which the propagation mode is a single mode (hereinafter referred to as “SM”), and a process for its production. More particularly, it relates to a plastic optical fiber for communications with a high bandwidth, which has transparency, heat resistance, moisture resistance, water proof, chemical resistance, non-flammability and flexibility all together and which is suitable particularly for e.g. plant wirings or wirings for sewage systems which are required to have chemical resistance, and of which the propagation mode is SM, and a process for its production.

Heretofore, as SM optical fibers, those made of glass have been known and have been practically used for large capacity long distance trunk line systems. In recent years, along with widespread use of internet and digitization of communication systems, it has become important to introduce optical fibers not only to relay networks connecting communication service centers but also to subscriber line networks connecting offices and homes. However, optical fibers made of glass are poor in flexibility and thus difficult to handle, and their connection requires special skills.

Under the circumstances, JP-A-5-241036 proposes SM type optical fibers employing acrylic resin plastic fibers which are excellent in flexibility and easy to handle. However, acrylic resins represented by methyl methacrylate resins, or polystyrene resins, have an attenuation loss by vibrational absorption attributable to C—H bonds, whereby light to be used for communications is restricted to visible light. Thus, near infrared light of e.g. 850 nm or 1,300 nm which is commonly used for communications, can not be used. Further, a theoretical attenuation loss is substantial, and the transmission distance is substantially limited to a level of at most 100 m, whereby such fibers cannot be used for establishing a network connecting buildings or floors.

Whereas, JP-A-8-5848 discloses that a graded index (hereinafter referred to as “GI”) optical fiber is produced by using a non-crystalline fluoropolymer having no C—H bond in its molecule, and the obtained optical fiber has a low attenuation loss to lights within a wide wavelength range from ultraviolet lights to near infrared lights. Further, a step index (hereinafter referred to as “SI”) optical fiber employing a non-crystalline fluoropolymer having no C—H bond in its molecule, is disclosed in e.g. JP-A-4-1704.

Such GI optical fiber is known to provide a large transmission capacity due to a high bandwidth as compared with the SI optical fiber. With respect to the GI optical fiber made of a non-crystalline fluoropolymer having no C—H bond, one at a level of 300 MHz·km has been developed by controlling the refractive index distribution, and theoretically, it may have a performance exceeding 10 GHz·km. However, a GI optical fiber having such high performance has not yet been realized.

On the other hand, the SM optical fiber is theoretically useful in a higher bandwidth than the GI optical fiber, and it is practically used as a glass optical fiber, but a SM optical fiber made of a non-crystalline fluoropolymer having no C—H bond, has not been prepared.

It is an object of the present invention to provide a SM plastic optical fiber which is easy to handle and safe (the optical fiber will not break or stick) and can be connected at a low cost and which can be laid for a short distance at a level of from a few hundreds meters to a few kilometers and has a large transmission capacity due to a high bandwidth and a low attenuation loss, and a process for its production.

Further, it is another object of the present invention to provide a SM plastic optical fiber which can be mutually connected with a SM optical fiber made of glass, and a process for its production.

Still further, it is an object of the present invention to provide a SM plastic optical fiber which has transparency, heat resistance, moisture resistance, water proof, chemical resistance, non-flammability and flexibility all together and which is particularly suitable for plant wirings or wirings for sewage systems which are required to have chemical resistance.

The present inventors have conducted an extensive study in view of the above-mentioned problems and as a result, have found that the propagation mode of a plastic optical fiber can be made to be a single mode by controlling the core diameter and the difference in the refractive index between the core and the clad, of a plastic optical fiber, by using specific fluoropolymers, and the present invention has been accomplished on the basis of this discovery.

That is, the present invention provides 1) a plastic optical fiber which comprises a core made of a non-crystalline fluoropolymer (a) having substantially no C—H bond, and a clad made of a fluoropolymer (b) having a refractive index lower by at least 0.001 than the fluoropolymer (a), and of which the propagation mode is a single mode.

Here, 2) it is preferred that each of the fluoropolymers (a) and (b) is a fluoropolymer having substantially no C—H bond and having a fluorine-containing aliphatic cyclic structure in its main chain.

Further, the present invention provides a process for producing a plastic optical fiber as defined in 1) or 2), which comprises melting the fluoropolymer (b) in a cylindrical container, injecting the fluoropolymer (a) to a center axis portion of the melt of the fluoropolymer (b), followed by cooling, or preparing a hollow cylinder of the fluoropolymer (b), followed by inserting the fluoropolymer (a), to form a preform, and further subjecting this preform to melt spinning.

Still further, the present invention provides a process for producing a plastic optical fiber as defined in 1) or 2), which comprises melt spinning by extrusion so that the fluoropolymer (a) is disposed at the center and the fluoropolymer (b) is disposed concentrically to surround it.

According to the present invention, it is possible to provide a SM plastic optical fiber which is easy to handle and safe (the optical fiber will not break or stick) and can be connected at a low cost, and which can be laid in a short distance and has a large transmission capacity due to a high bandwidth and a low attenuation loss, and a process for its production.

Further, the SM plastic optical fiber of the present invention can be connected with a SM optical fiber made of glass.

Further, the SM plastic optical fiber of the present invention has transparency, heat resistance, moisture resistance, water proof, chemical resistance, non-flammability and flexibility all together and can be suitably used under severe conditions for e.g. plant wirings or sewage wirings where chemical resistance is particularly required.

Now, the present invention will be described in detail with reference to the preferred embodiments.

The plastic optical fiber of the present invention is a plastic optical fiber comprising a core made of a non-crystalline fluoropolymer (a) having substantially no C—H bond and a clad made of a fluoropolymer (b) having a refractive index lower by at least 0.001 than the fluoropolymer (a), and of which the propagation mode is a single mode.

In the present invention, the refractive index is meant for a refractive index to sodium D line.

In the present invention, the fluoropolymer (a) is not particularly limited, so long as it is a fluoropolymer which is non-crystalline and which has substantially no C—H bond attributable to light absorption of near infrared light. However, a fluoropolymer having a fluorine-containing aliphatic cyclic structure in its main chain, is preferred. In the present invention, the fluoropolymer (b) is preferably a fluoropolymer which is non-crystalline and which has substantially no C—H bond causing light absorption of near infrared light. Namely, the fluoropolymer (b) is preferably a fluoropolymer of the same type as the fluoropolymer (a) so long as it has a refractive index lower than the fluoropolymer (a) to be combined. As the fluoropolymer (b), particularly preferred is a fluoropolymer having a fluorine-containing aliphatic cyclic structure in its main chain. Further, each of the fluoropolymers (a) and (b) is a polymer having a melt-moldability and is usually a substantially linear polymer.

Now, firstly, the fluoropolymer which is non-crystalline and has substantially no C—H bond causing light absorption of near infrared light, and which has a fluorine-containing aliphatic cyclic structure in its main chain, will be described. It is preferred to use two types of fluoropolymers selected from such fluoropolymers and having different refractive indices, as the fluoropolymers (a) and (b), respectively.

The fluoropolymer having a fluorine-containing aliphatic cyclic structure in its main chain, is a fluoropolymer having a main chain made of a chain of carbon atoms and having a fluorine-containing aliphatic cyclic structure in the main chain. “Having a fluorine-containing aliphatic cyclic structure in its main chain” is meant for having a structure wherein at least one carbon atom constituting an aliphatic ring is a carbon atom in the carbon chain constituting the main chain, and a fluorine atom or a fluorine-containing group is bonded to at least part of carbon atoms constituting the aliphatic ring. As the fluorine-containing aliphatic cyclic structure, a fluorine-containing aliphatic ether cyclic structure is more preferred.

The viscosity of the fluoropolymer in a molten state is preferably from 1×10² to 1×10⁵ Pa.S at a melting temperature of from 200 to 300° C. If the melt viscosity is too high, melt spinning is difficult, and if the melt viscosity is too low, the polymer softens when exposed at a high temperature to form a cable by applying a protective coating, whereby the light transmitting performance deteriorates.

The number average molecular weight of the fluoropolymer is preferably from 1×10⁴ to 5×10⁶, more preferably from 5×10⁴ to 1×10⁶. If the molecular weight is too small, the heat resistance may be impaired, and if it is too large, molding or melt extrusion of the preform tends to be difficult. When this molecular weight is represented by the intrinsic viscosity [η], it is preferably from 0.1 to 1 d^{▪}/g, particularly preferably from 0.2 to 0.5 d^{▪}/g, at 30° C. in perfluoro(2-butyltetrahydrofuran) (hereinafter referred to as “PBTHF”).

The polymer having a fluorine-containing aliphatic cyclic structure, is preferably a polymer obtained by polymerizing a monomer having a fluorine-containing aliphatic cyclic structure (a monomer having a polymerizable double bond between a carbon atom constituting a ring and a carbon atom not constituting a ring, or a monomer having a polymerizable double bond between two carbon atoms constituting a ring), or a polymer having a fluorine-containing aliphatic cyclic structure in its main chain, obtained by cyclic polymerization of a fluoromonomer having at least two polymerizable double bonds. The above-mentioned monomer having a fluorine-containing aliphatic cyclic structure is preferably a monomer having one polymerizable double bond. And the above cyclic polymerizable fluorine-containing monomer is preferably a monomer having two polymerizable double bonds and having no fluorine-containing aliphatic cyclic structure.

In this invention, a monomer which is copolymerizable with above-mentioned monomers, excluding both the monomer having a fluorine-containing aliphatic cyclic structure and the cyclic polymerizable fluorine-containing monomer, is referred to as “other radical polymerizable monomer”.

The carbon atoms constituting the main chain of the fluoropolymer are constituted by two carbon atoms of the polymerizable double bond of a monomer. Accordingly, in a monomer having a fluorine-containing aliphatic cyclic structure having one polymerizable double bond, one or both of the two carbon atoms constituting the polymerizable double bond will be atoms constituting the aliphatic ring. With the fluoromonomer having no aliphatic ring and having two polymerizable double bonds, one carbon atom of one polymerizable double bond and one carbon atom of the other polymerizable double bond will bond to form a ring. An aliphatic ring is formed by the bonded two carbon atoms and atoms present between them (excluding atoms in a side chain), and in a case where an etheric oxygen atom is present between the two polymerizable double bonds, a fluorine-containing aliphatic ether cyclic structure will be formed.

The polymer having a fluorine-containing aliphatic cyclic structure in its main chain, obtainable by polymerization of a monomer having a fluorine-containing aliphatic cyclic structure, can be obtained by homopolymerizing a monomer having a fluorine-containing aliphatic cyclic structure, such as perfluoro(2,2-dimethyl-1,3-dioxol), perfluoro(4-methyl-2-methylene-1,3-dioxolane) or perfluoro(2-methyl-1,4-dioxine). Further, a polymer having a fluorine-containing aliphatic cyclic structure in its main chain, obtained by copolymerizing such a monomer with the other radical polymerizable monomer containing no C—H bond, may also be employed. If the proportion of polymerized units of the other radical polymerizable monomer increases, the light transmittance of the fluoropolymer may decrease. Accordingly, the fluoropolymer is preferably a homopolymer of a monomer having a fluorine-containing aliphatic cyclic structure, or a copolymer wherein the proportion of polymerized units of such a monomer, is at least 70 mol %. The other radical polymerizable monomer containing no C—H bond, may, for example, be tetrafluoroethylene or chlorotrifluoroethylene. As a commercially available non-crystalline fluoropolymer having substantially no C—H bond, of this type, “Teflon AF” (manufactured by Du Pont) or “Hiflon AD” (manufactured by Ausimont) may, for example, be mentioned.

Further, the polymer having a fluorine-containing aliphatic cyclic structure in its main chain, obtainable by cyclic polymerization of a fluorine-containing monomer having at least two polymerizable double bonds, is known, for example, in JP-A-63-238111 or JP-A-63-238115. Namely, a polymer having a fluorine-containing aliphatic cyclic structure in its main chain, can be obtained by cyclic polymerization of a monomer such as perfluoro(3-oxa-1,5-hexadiene) or perfluoro(3-oxa-1,6-heptadiene), or by copolymerizing such a monomer with the other radical polymerizable monomer containing no C—H bond such as tetrafluoroethylene, chlorotrifluoroethylene or perfluoro(methyl vinyl ether). As a fluorine-containing monomer having at least two polymerizable double bonds other than the above, perfluoro(4-methyl-3-oxa-1,6-heptadiene) or perfluoro(5-methyl-3-oxa-1,6-heptadiene) may, for example, be also preferred. If the proportion of polymerized units of the other radical polymerizable monomer increases, the light transmittance of the fluoropolymer may decrease. Accordingly, as the fluoropolymer, a homopolymer of a fluoromonomer having at least two polymerizable double bonds, or a copolymer wherein the proportion of polymerized units of such a monomer is at least 40 mol %, is preferred. As a commercially available non-crystalline fluoropolymer having substantially no C—H bond, of such a type, “Cytop” (manufactured by Asahi Glass Company, Limited) may be mentioned.

Further, the fluoropolymer having a fluorine-containing aliphatic cyclic structure in its main chain, may also be obtained by copolymerizing a monomer having a fluorine-containing aliphatic cyclic structure such as perfluoro(2,2-dimethyl-1,3-dioxol) with a fluorine-containing monomer having at least two polymerizable double bonds such as perfluoro(3-oxa-l,5-hexadiene) or perfluoro(3-oxa-1,6-heptadiene). Also in such a case, the light transmittance may decrease depending upon the combination. Accordingly, a copolymer wherein the proportion of polymerized units of the fluoromonomer having at least two polymerizable double bonds, is at least 30 mol %, is preferred.

The polymer having a fluorine-containing aliphatic cyclic structure is preferably one containing at least 20 mol %, particularly preferably at least 40 mol %, of polymerized units having a fluorine-containing aliphatic cyclic structure, based on the total polymerized units of the polymer having a fluorine-containing aliphatic cyclic structure, from the viewpoint of transparency, mechanical properties, etc.

Further, the polymer having a fluorine-containing aliphatic cyclic structure is preferably a perfluoropolymer. Namely, it is preferably a polymer wherein all of hydrogen atoms bonded to carbon atoms are substituted by fluorine atoms. However, some of fluorine atoms in the perfluoropolymer may be substituted by atoms other than hydrogen atoms, such as chlorine atoms or deuterium atoms. The presence of chlorine atoms is effective to increase the refractive index of the polymer. Accordingly, a polymer having chlorine atoms may be used particularly as the fluoropolymer (a).

The fluoropolymer (b) is used as a clad material, and its refractive index is required to be lower by at least 0.001 than the fluoropolymer (a). Further, the allowance for the required performance of light transmittance of the fluoropolymer (b) is larger than the fluoropolymer (a), and accordingly, the fluoropolymer (b) may have a small amount of hydrogen atoms. However, the presence of hydrogen atoms may cause absorption of transmitted light, and as compared with fluorine atoms, the presence of hydrogen atoms tends to increase the refractive index of the polymer. For such reasons, the fluoropolymer (b) is preferably a polymer having substantially no hydrogen atom. Further, for example, the proportion of polymerized units having a fluorine-containing aliphatic cyclic structure, based on the total polymerized units of the polymer having a fluorine-containing aliphatic cyclic structure, may sufficiently be at a level of 20 mol %. Whereas, in the case of fluoropolymer (a) such a proportion is preferably at least 40 mol %. For example, in a case where the fluoropolymer (b) is a copolymer of a monomer having a fluorine-containing aliphatic cyclic structure with another radical polymerizable monomer, the proportion of polymerized units of a monomer having a fluorine-containing aliphatic cyclic structure, in the fluoropolymer (b), may be small and may sufficiently be useful even at a level of 30 mol %.

In the present invention, each of the fluoropolymers (a) and (b) is preferably the above-described fluoropolymer having a fluorine-containing aliphatic cyclic structure in its main chain, but is not limited to such a fluoropolymer. For example, it is possible to use a non-crystalline fluoropolymer having substantially no C—H bond and having a fluorine-containing cyclic structure other than the fluorine-containing aliphatic cyclic structure, in its main chain, as disclosed in the above-mentioned JP-A-8-5848. Specifically, it is possible to use a non-crystalline fluoropolymer having in its main chain a fluorine-containing cyclic structure such as a fluorine-containing imide ring structure, a fluorine-containing triazine ring structure or a fluorine-containing aromatic ring structure. The melt viscosity and the number average molecular weight of such a polymer are preferably within the ranges equivalent to the above-mentioned melt viscosity and the number average molecular weight of the fluoropolymer having a fluorine-containing aliphatic cyclic structure in its main chain.

In the optical fiber of the present invention, the core and the clad are made of plastic materials (fluoropolymers). Accordingly, the core will not break like an optical fiber made of glass, or the core at the end of the optical fiber will not stick and is safe.

Further, as fluoropolymers are used for the core and the clad, the optical fiber has transparency, heat resistance, moisture resistance, water proof, chemical resistance, non-flammability and flexibility all together, and such an optical fiber can be preferably employed particularly for e.g. plant wirings or sewage wirings which are required to have chemical resistance. Further, the optical fiber has flexibility, etc. and is easy to handle and connect, and such an optical fiber can suitably be employed for establishing of a subscriber line network connecting offices or homes, or a network connecting buildings or floors.

The plastic optical fiber of the present invention is a plastic optical fiber, of which the propagation mode is a single mode.

The conditions for the single mode may be represented by the formula (1) by means of parameters so-called normalized frequency V:

$$V = \frac{2 π a}{λ} \sqrt{{n}_{1}^{2} - {n}_{2}^{2}} < 2.405 \qquad ( 1 )$$

where a is the core radius, n₁ is the refractive index of the core center, n₂ is the refractive index of the clad, and λ is the wavelength.

A SM plastic optical fiber of the present invention comprises a core made of a fluoropolymer (a) and a clad made of a fluoropolymer (b) having a refractive index lower by at least 0.001 than the fluoropolymer (a). In such a case, with respect to the relation of the refractive indices n₁ and n₂ of the fluoropolymers (a) and (b) required to satisfy the formula (1), Δn=n₁−n₂ is preferably within a range of 0.001≦Δn<0.01.

If Δn is smaller than this, light can not be sealed in, and the bending loss tends to increase. On the other hand, if it is larger than this, the core diameter must be made very small in order to satisfy the SM conditions, and it becomes difficult to let light enter.

By controlling the core diameter of the plastic optical fiber and the difference of the refractive indices of the core and the clad so that the propagation mode of the plastic optical fiber is made to be a single mode, it is possible to realize a low attenuation loss with a large transmission capacity due to a high bandwidth. Further, since the propagation mode is the same, the mutual connection with a SM optical fiber made of glass will be possible.

The diameter of the SM plastic optical fiber of the present invention is preferably at least 20 μm, more preferably at least 50 μm. If the diameter is too small, the handling in e.g. connection, tends to be difficult, and it tends to be difficult to make the propagation mode to be a single mode. There is no particular upper limit in the diameter. However, if the diameter is too large, the cost for material increases, and the economical efficiency lowers. Taking the economical efficiency, etc., into account, the upper limit is preferably about 800 μm. Particularly preferably, the diameter of the fiber is from 100 to 800 μm.

The plastic optical fiber of the present invention can be produced by processes which will be described hereinafter.

Further, with respect to the applications, the plastic optical fiber of the present invention can be used for laying for a short distance of from about a few hundreds meters to a few kilometers or for connection (a branch line) to a glass SM optical fiber or under severe conditions for use, and it is used particularly suitably for laying for a short distance.

As the process for producing the SM plastic optical fiber of the present invention, (A) a process of molding a preform and then subjecting the preform to melt spinning, or (B) a process of melt spinning by means of an extrusion molding machine, may be employed. In each case, it is possible to directly preparing it from the polymers or mold it while polymerizing the monomers.

A preform may be formed by melting the fluoropolymer (b) in a cylindrical container, injecting the fluoropolymer (a) into a center axis portion of the melt of the fluoropolymer (b), followed by cooling. Further, a preform may also be formed by preparing a hollow cylinder of the fluoropolymer (b) by melt molding etc., followed by inserting the fluoropolymer (a). Further, a hollow cylinder of the fluoropolymer (b) may be formed by bulk polymerization of a monomer of the fluoropolymer (b). As a method of inserting the fluoropolymer (a) into the hollow cylinder of the fluoropolymer (b), injecting the fluoropolymer (a) in a molten state, inserting the fluoropolymer (a) molded in a rod shape, or filling the monomer of the fluoropolymer (a), followed by bulk polymerization, may be employed.

As a method for melt spinning from the above-mentioned preform, the following method may be employed. While inserting the preform into a cylindrical heating furnace at a constant speed of v₁, it is melted from the forward end, made into a slender fiber shape and withdrawn at a constant speed v₂ to obtain a fiber having a predetermined diameter. The relation of v₁ and v₂ will be

$$\frac{{r}_{2}}{{r}_{1}} = \sqrt{\frac{{v}_{1}}{{v}_{2}}} \qquad ( 2 )$$

where r₁ is the core diameter of the initial preform, and r₂ is the core diameter of the fiber, since the volume is constant as represented by v₁πr₁²=v₂πr₂². Accordingly, the core/clad ratio is determined by the core/clad ratio of the preform, and if the core diameter is changed, the clad diameter will also be changed, whereby freedom in design will be limited.

On the other hand, by the method of melt spinning by means of an extrusion molding machine, it is possible to produce a fiber having an optional size by changing the rotational speed of the screw or the size of the nozzle, and continuous production is possible, whereby the productivity is good. However, the method may be a combination of both, i.e. the preform may be produced by extrusion, followed by melt spinning.

Now, the present invention will be described in further detail with reference to specific Examples. However, it should be understood that the present invention is by no means restricted to such specific Examples.

### PREPARATION EXAMPLE 1

30 g of perfluoro(3-oxa-1,6-heptadiene) (hereinafter referred to as “PBVE”), 150 g of deionized water, 10 g of methanol and 0.15 g of diisopropylperoxydicarbonate as a polymerization initiator, were charged into an autoclave made of pressure resistant glass and having an internal capacity of 200 m^{▪}. The interior of the system was flushed three times with nitrogen, whereupon suspension polymerization was carried out at 40° C. for two hours. The resulted polymer was stabilized by fluorination, followed by purification. As a result, 26 g of a purified polymer (hereinafter referred to as “polymer A”) was obtained. The intrinsic viscosity [η] of polymer A was 0.24 at 30° C. in PBTHF. The glass transition temperature of polymer A as measured by differential scanning calorimetry (hereinafter referred to as “DSC”) was 108° C., and it was a transparent glassy polymer which was tough at room temperature. Further, the 10% heat decomposition temperature was 468° C., and the refractive index was 1.342.

### PREPARATION EXAMPLE 2

27 g of PBVE, 3 g of perfluoro(2,2-dimethyl-1,3-dioxol) (hereinafter referred to as “PDD”), 0.15 g of deionized water, 10 g of methanol and 0.15 g of diisopropylperoxydicarbonate, were charged into an autoclave made of pressure resistant glass and having an internal capacity of 200 m^{▪}. The interior of the system was flushed three times with nitrogen, whereupon suspension polymerization was carried out at 40° C. for 22 hours. The resulted polymer was stabilized by fluorination, followed by purification. As a result, 27 g of a purified polymer (hereinafter referred to as “polymer B”) was obtained.

The intrinsic viscosity [η] of polymer B was 0.25 at 30° C. in PBTHF. From the analysis of the IR spectrum, the content of repeating units (hereinafter referred to as “PDD polymerized units”, the same applies hereinafter) formed by the polymerization reaction of PDD, was 10 mol %. The glass transition temperature of polymer B as measured by DSC was 115° C., and it was a transparent glassy polymer which was tough at room temperature. Further, the 10% heat decomposition temperature was 465° C., and the refractive index was 1.337.

### PREPARATION EXAMPLE 3

20 g of PBVE, 10 g of tetrafluoroethylene (hereinafter referred to as “TFE”), 30 g of dichloropentafluoropropane (hereinafter referred to as “R225”) and 30 mg of perfluorobenzoyl peroxide, were charged into an autoclave made of stainless steel and having an internal capacity of 200 m^{▪}. The interior of the system was frozen in liquid nitrogen, vacuum-deaerated, whereupon solution polymerization was carried out at 70° C. for 20 hours, followed by purification. As a result, 25 g of a purified polymer (hereinafter referred to as “polymer C”) was obtained.

The intrinsic viscosity [η] of polymer C was 0.27 at 30° C. in PBTHF. From the analysis of the NMR spectrum, the molar ratio of PBVE polymerized units:TFE polymerized units was 46:54. The glass transition temperature of polymer C as measured by DSC, was 82° C., and it was a transparent glassy polymer which was tough at room temperature. Further, the 10% heat decomposition temperature was 468° C., and the refractive index was 1.338.

### PREPARATION EXAMPLE 4

22 g of PBVE, 8 g of perfluoro(2-methylene-4-methyl-1,3-dioxolane) (hereinafter referred to as “PMMD”), 150 g of deionized water, 10 g of methanol and 0.15 g of diisopropylperoxydicarbonate, were charged into an autoclave made of pressure resistant glass and having an internal capacity of 200 m^{▪}. The interior of the system was flushed three times with nitrogen, whereupon suspension polymerization was carried out at 40° C. for 22 hours. The resulted polymer was stabilized by fluorination, followed by purification. As a result, 26.6 g of a purified polymer (hereinafter referred to as “polymer D”) was obtained.

The intrinsic viscosity [η] of polymer D was 0.27 at 30° C. in PBTHF. From the analysis of the NMR spectrum, the molar ratio of PBVE polymerized units:PMMD polymerized units was 68:32. The glass transition temperature of polymer D as measured by DSC, was 114° C., and it was a transparent glassy polymer which was tough at room temperature. Further, the 10% heat decomposition temperature was 447° C., and the refractive index was 1.338.

### PREPARATION EXAMPLE 5

8 g of PBVE, 7 g of 2,2-bis(trifluoromethyl)-1,3-dioxol (hereinafter referred to as “HFDD”), 8 g of TFE, 10 g of R225 and 50 mg of perfluorobenzoyl peroxide, was charged into an autoclave made of stainless steel and having an internal capacity of 200 m^{▪}. The interior of the system was frozen in liquid nitrogen, vacuum-deaerated, whereupon solution polymerization was carried out at 70° C. for 20 hours, followed by purification. As a result, 4.7 g of a purified polymer (hereinafter referred to as “polymer E”) was obtained.

The intrinsic viscosity [η] of polymer E was 0.24 at 30° C. in PBTHF. From the analysis of the NMR spectrum, the molar ratio of PBVE polymerized units:HFDD polymerized units:TFE polymerized units was 50:15:35. The glass transition temperature of polymer E as measured by DSC, was 80° C., and it was a transparent glassy polymer which was tough at room temperature. Further, the 10% heat decomposition temperature was 462° C., and the refractive index was 1.338.

### PREPARATION EXAMPLE 6

2 g of perfluoro(4-methyl-3-oxa-1,6-heptadiene) and 6.2 mg of diisopropylperoxydicarbonate, were charged into a glass ampule, frozen in liquid nitrogen, vacuum-deaerated and then sealed. After heating at 40° C. for 20 hours in an oven, the solidified content was taken out and dried at 200° C. for one hour. The resulted polymer was stabilized by fluorination, followed by purification. The yield of the obtained polymer (hereinafter referred to as polymer F) was 99%. The refractive index of the film of polymer F prepared by press molding was 1.328 as measured by Abbe refractometer, and the glass transition temperature as measured by dynamic thermomechanical analysis (DMA), was 124° C.

### EXAMPLE 1

Polymer B was put into a cylindrical stainless steel container having an inner diameter of 3.3 cm and melted. At that time, a stainless steel rod having an outer diameter of 1.1 mm was inserted to the center portion, followed by cooling for solidification. The stainless steel rod was withdrawn, and the molded hollow rod (25 cm) of polymer B was taken out from the container. Then, using polymer A, a rod having an outer diameter of 1 mm and a length of 25 cm, was prepared separately and inserted into the hollow rod of polymer B, to obtain a preform comprising a core made of polymer A (refractive index: 1.342) and a clad made of polymer B (refractive index: 1.337).

This preform was sent into a cylindrical electric furnace heated to 240° C. at a speed of v₁=0.57 mm/min from one end, and a fiber was withdrawn at a speed of v₂=10 m/min. At that time, the space between the core and the clad of the preform was slightly vacuumed to a reduced pressure of 94 kPa to bring the core and the clad in close contact with each other. The outer diameter of the fiber thus obtained, was 0.25 mm. The core diameter at that time was about 8 μm from calculation, and the normalized frequency was V=2.24 to a power source with a wavelength of 1.3 μm, whereby the condition for a single mode was satisfied.

From one end of this fiber, light was permitted to enter by means of a laser diode (hereinafter referred to as LD) having a wavelength of 1.3 μm as a light source, and the intensity distribution of outgoing light was measured by a near field pattern (hereinafter referred to as “NFP”) method, whereby the mode field diameter was measured and found to be 10 μm. Further, by a bending method, the cutoff wavelength was measured and found to be 1.25 μm. Further, by a cut-back method, the attenuation loss was measured at a wavelength of 1.3 μm, and found to be 20 dB/km.

### EXAMPLE 2

Polymer C was put into a cylindrical stainless steel container having an inner diameter of 3.3 cm and melted. At that time, a stainless steel rod having an outer diameter of 1.1 mm was inserted into the center portion, followed by cooling for solidification. The stainless steel rod was withdrawn, and the molded hollow rod (25 cm) of polymer C was taken out from the container. Then, using polymer A, a rod having an outer diameter of 1 mm and a length of 25 cm, was prepared separately and inserted into the hollow rod of polymer C, to obtain a preform comprising a core made of polymer A (refractive index: 1.342) and a clad made of polymer C (refractive index: 1.338).

This preform was sent into a cylindrical electric furnace heated to 230° C. at a speed of v₁=0.57 mm/min from one end, and a fiber was withdrawn at a speed of v₂=10 m/min. At that time, the space between the core and the clad of the preform was slightly vacuumed to a reduced pressure of 94 kPa to bring the core and the clad in close contact with each other. The outer diameter of the fiber thus obtained, was 0.25 mm. The core diameter at that time was about 8 μm from calculation, and the normalized frequency was V=2.00 to a light source with a wavelength of 1.3 μm, whereby the condition for a single mode was satisfied.

From one end of this fiber, light was permitted to enter by means of LD having a wavelength of 1.3 μm as a light source, and the intensity distribution of outgoing light was measured by NFP method, whereby the mode field diameter was measured and found to be 10 μm. Further, by a bending method, the cutoff wavelength was measured and found to be 1.2 μm.

### EXAMPLE 3

By means of a screw extruder, double extrusion was carried out at a temperature of from 250 to 270° C. so that polymer A (refractive index: 1.342) was located at the center, and polymer D (refractive index: 1.338) was located around it. At that time, the outer diameter of the polymer extruded was 20 mm at the die outlet, and the polymer was drawn to an outer diameter of 0.2 mm to obtain a fiber. The winding up speed of the fiber at that time was 12 m/min. The core diameter at that time was about 8 μm from calculation, and the normalized frequency was V=2.00 to a light source having a wavelength of 1.3 μm, whereby the condition for a single mode was satisfied.

From one end of this fiber, light was permitted to enter by means of LD having a wavelength of 1.3 μm as a power source, and the intensity distribution of outgoing light was measured by NFP method, whereby the mode field diameter was measured and found to be 10 μm. Further, by a bending method, the cutoff wavelength was measured and found to be 1.2 μm.

### EXAMPLE 4

Using polymer E, a preform comprising a core made of polymer A (refractive index: 1.342) and a clad made of polymer E (refractive index: 1.338), was obtained in the same manner as in Example 1.

This preform was sent into a cylindrical electric furnace heated to 240° C. at a speed of v₁=0.57 mm/min from one end, and a fiber was withdrawn at a speed of v₂=10 m/min. At that time, the space between the core and the clad of the preform was slightly vacuumed to a reduced pressure of 94 kPa to bring the core and the clad in close contact with each other. The outer diameter of the fiber thus obtained, was 0.25 mm. The core diameter at that time was about 8 μm from calculation, and the normalized frequency was V=2.00 to a light source with a wavelength of 1.3 μm, whereby the condition for a single mode was satisfied.

From one end of this fiber, light was permitted to enter by means of LD having a wavelength of 1.3 μm as a power source, and the intensity distribution of outgoing light was measured by NFP method, whereby the mode field diameter was measured and found to be 10 μm. Further, by a bending method, the cutoff wavelength was measured and found to be 1.2 μm.

### EXAMPLE 5

Using polymer F, a fiber comprising a core made of polymer A (refractive index: 1.342) and a clad made of polymer F (refractive index: 1.328), was obtained in the same manner as in Example 3. The outer diameter of this fiber was 0.5 mm. The core diameter at that time was 4 μm, and the normalized frequency was V=1.87 to a light source having a wavelength of 1.3 μm, whereby the condition for a single mode was satisfied.

From one end of this fiber, light was permitted to enter by means of LD having a wavelength of 1.3 μm as a power source, and the intensity distribution of outgoing light was measured by NFP method, whereby the mode field diameter was measured and found to be 5 μm. Further, by a bending method, the cutoff wavelength was measured and found to be 1.1 μm.

### EXAMPLE 6

Using Hiflon AD i.e. a fluoropolymer manufactured by Ausimont, a preform comprising a core made of polymer F (refractive index: 1.328) and a clad made of Hiflon AD (refractive index: 1.325), was obtained in the same manner as in Example 1.

This preform was sent into a cylindrical electric furnace heated to 250° C. at a speed of v₁=0.57 mm/min from one end, and a fiber was withdrawn at a speed of v₂=10 m/min. At that time, the space between the core and the clad of the preform was slightly vacuumed to a reduced pressure of 94 kPa to bring the core and the clad in close contact with each other. The outer diameter of the fiber thus obtained, was 0.25 mm. The core diameter at that time was about 8 μm from calculation, and the normalized frequency was V=1.72 to a light source with a wavelength of 1.3 μm, whereby the condition for a single mode was satisfied.

From one end of this fiber, light was permitted to enter by means of LD having a wavelength of 1.3 μm as a power source, and the intensity distribution of outgoing light was measured by NFP method, whereby the mode field diameter was measured and found to be 10 μm. Further, by a bending method, the cutoff wavelength was measured and found to be 1.0 μm.

### EXAMPLE 7

Using Hiflon AD and Teflon AF manufactured by Du Pont, a fiber comprising a core made of Hiflon AD (refractive index: 1.325) and a clad made of Teflon AF (refractive index: 1.31), was obtained in the same manner as in Example 3. The outer diameter of this fiber was 0.3 mm. The core diameter at that time was 4 μm, and the normalized frequency was V=1.92 to a light source having a wavelength of 1.3 μm, whereby the condition for a single mode was satisfied.

From one end of this fiber, light was permitted to enter by means of LD having a wavelength of 1.3 μm as a power source, and the intensity distribution of outgoing light was measured by NFP method, whereby the mode field diameter was measured and found to be 5 μm. Further, by a bending method, the cutoff wavelength was measured and found to be 1.2 μm.

As described in the foregoing, according to the present invention, it is possible to provide a SM plastic optical fiber having a low attenuation loss and a large transmission capacity due to a high bandwidth, which is easy to handle and safe (the optical fiber is free from breakage or sticking) and which is capable of laying for a short distance at a level of a few hundreds meters to a few kilometers with low costs for connection, and a process for its production.

Further, according to the present invention, it is possible to provide a plastic optical fiber which is capable of mutual connection with a SM optical fiber made of glass, and a process for its production. Further, according to the present invention, by employing a non-crystalline fluorine-containing material, particularly a polymer having a fluorine-containing aliphatic cyclic structure, the material distribution can be made smaller than glass and acrylic resin, and it is possible to provide a plastic optical fiber for a higher bandwidth, and a process for its production.

Furthermore, according to the present invention, it is possible to provide a plastic optical fiber which has transparency, heat resistance, moisture resistance, water proof, chemical resistance, non-flammability and flexibility all together and which is suitable particularly for plant wirings or sewage wirings which are required to have chemical resistance, and a process for its production.

The entire disclosure of Japanese Patent Application No. 2001-218380 filed on Jul. 18, 2001 including specification, claims and summary are incorporated herein by reference in its entirety.

What is claimed is:

1. A plastic optical fiber which comprises a core made of a non-crystalline fluoropolymer (a) having substantially no C—H bond, and a clad made of a fluoropolymer (b) having a refractive index lower by at least 0.001 than the fluoropolymer (a), and of which the propagation mode is a single mode.

2. The plastic optical fiber according to claim 1, wherein the relation between n₁ and n₂ satisfies 0.001≦n₁−n₂^{▪}0.01, where n₁ is the refractive index of the fluoropolymer (a), and n₂ is the refractive index of the fluoropolymer (b).

3. The plastic optical fiber according to claim 1, wherein the outer diameter of the plastic fiber is from 100 to 800 μm.

4. The plastic optical fiber according to claim 1, wherein the relation between n₁ and n₂ satisfies 0.001≦n₁−n₂^{▪}0.01, where n₁ is the refractive index of the fluoropolymer (a), and n₂ is the refractive index of the fluoropolymer (b), and the outer diameter of the plastic fiber is from 100 to 800 μm.

5. The plastic optical fiber according to claim 1, wherein the fluoropolymer (b) is a non-crystalline fluoropolymer having substantially no C—H bond.

6. The plastic optical fiber according to claim 5, wherein the fluoropolymer (b) is a fluoropolymer having a fluorine-containing aliphatic cyclic structure in its main chain.

7. The plastic optical fiber according to claim 5, wherein the relation between n₁ and n₂ satisfies 0.001≦n₁−n₂^{▪}0.01, where n₁ is the refractive index of the fluoropolymer (a), and n₂ is the refractive index of the fluoropolymer (b).

8. The plastic optical fiber according to claim 5, wherein the outer diameter of the plastic fiber is from 100 to 800 μm.

9. The plastic optical fiber according to claim 5, wherein the relation between n₁ and n₂ satisfies 0.001≦n₁−n₂^{▪}0.01, where n₁ is the refractive index of the fluoropolymer (a), and n₂ is the refractive index of the fluoropolymer (b), and the outer diameter of the plastic fiber is from 100 to 800 μm.

10. The plastic optical fiber according to claim 1, wherein the fluoropolymer (a) is a fluoropolymer having a fluorine-containing aliphatic cyclic structure in its main chain.

11. The plastic optical fiber according to claim 1, wherein each of the fluoropolymers (a) and (b) is a fluoropolymer having substantially no C—H bond and having a fluorine-containing aliphatic cyclic structure in its main chain.

12. A process for producing a plastic optical fiber as defined in claim 1, which comprises melting the fluoropolymer (b) in a cylindrical container, injecting the fluoropolymer (a) into a center axis portion of the melt of the fluoropolymer (b), followed by cooling, or preparing a hollow cylinder of the fluoropolymer (b), followed by inserting the fluoropolymer (a), to form a preform, and further subjecting this preform to melt spinning.

13. A process for producing a plastic optical fiber as defined in claim 1, which comprises melt spinning by extrusion so that the fluoropolymer (a) is disposed at the center and the fluoropolymer (b) is disposed concentrically to surround it.
